(19) United States
(12) Patent Application Publication
(10) Pub. No.: US 2017/0038058 A1
(43) Pub. Date: Feb. 9, 2017

(54) Vertical Linear Cabinet Lights

(71) Applicant: American Glasscrafters, Inc., Carlstadt, NJ (US)

(72) Inventors: Joseph F. Cano, Ridgewood, NJ (US); Michael M. Balagyozyan, Wayne, NJ (US); Robert P. Pandorf, Yardley, PA (US)

(73) Assignee: American Glasscrafters, Inc., Carlstadt, NJ (US)

(21) Appl. No.: 15/231,116

(22) Filed: Aug. 8, 2016

Related U.S. Application Data
(60) Provisional application No. 62/202,222, filed on Aug. 7, 2015.

(51) Int. Cl. F21V 33/00; A47B 67/02; A47B 67/00

(52) U.S. Cl. CPC F21V 33/004; A47B 67/005; A47B 67/02; A47B 2220/0077; F21Y 2115/10

(57) ABSTRACT

A pair of vertical linear side mounted lights for a cabinet with a mirrored door are disclosed. The vertical linear side mounted lights are an assembly of a rectangular box attachment section and a light diffuser housing. The light diffuser housing, containing LED light strips, is attached to the front of the rectangular box attachment section, containing the power source for the LED light strips, to create the rectangular box attachment section/light diffuser panel assembly. This assembly is affixed to the vertical side walls of a cabinet with a mirrored door. The light diffuser panel on the front of the assembly is oriented so as to angle the light toward the person standing in front the mirror. A preferred embodiment is for use of the vertical linear side mounted lights on a medicine cabinet with a mirrored front door.

### PRIORITY

This application claims priority to U.S. Provisional Application No. 62/202,222 filed Aug. 7, 2015

### BACKGROUND OF INVENTION

The present invention is directed to a set of vertical linear mounted lights on the sides of a mirrored door cabinet and the mirrored door cabinet with the set of vertical linear mounted lights affixed. Specifically, a rectangular box with a light diffuser assembly on the front and a light source inside the assembly. The front diffuser panels are oriented at an angle to the mirrored face of the cabinet such that the focal point of the light emitted from each diffuser panel converges at a point where the user of the mirrored cabinet will be standing. The preferred embodiment of the present invention is a medicine cabinet with a mirrored door where the diffuser panels are oriented at 15 degrees to the face of the mirrored door and the light source is a light-emitting diode (LED) strip.

The prior art discloses illuminated attachments (removable and fixed) to the sides and top of mirrored door cabinets. The prior art deals with fixed light attachments to the sides of mirrored door cabinets where these attachments hinged so that they are capable of adjusting and recessing. In this regard, see U.S. Pat. No. 1,918,047 Marchand; U.S. Pat. No. 1,948,111 Hoegger; U.S. Pat. No. 1,948,112 Hoegger and U.S. Pat. No. 2,677,751 Marchand. U.S. Pat. No. 1,948,111 Hoegger discloses frame mounted adjustable vertical side lights which can be set at an angle to the mirrored surface of the cabinet door. This prior art does not disclose the side lights being fixed to the sides of the mirrored face cabinet with a nonadjustable light diffuser orientation and in fact teaches away (see U.S. Pat. No. 1,948,111 Hoegger page 1, lines 24-37) from this embodiment. The present invention provides attachable vertical side lights mounted and connected directly to the sides of a mirrored face cabinet with the light diffuser panel oriented at the optimum angle to the mirror based on the location of the person using the mirror.

### BRIEF SUMMARY OF INVENTION

A pair of vertical linear light attachments for a mirrored face cabinet each comprising a rectangular box attachment section with an inner side panel, an outer side panel, a back panel and a front panel all made from an opaque material, a light diffuser housing with a face panel and two side panels adapted to be attached to the rectangular box attachment section, a top cap section and a bottom cap section adapted to be attached to the front panel of the rectangular box attachment section where the top cap section and the bottom cap section cover the top and bottom of both the rectangular box attachment section and light diffuser housing, the light diffuser housing made from translucent material, the top cap section and the bottom cap section made from opaque material, the inner side panel of the rectangular box attachment section adapted to be mounted to the outer vertical side walls of the mirrored face cabinet to affix the rectangular box attachment section and light diffuser housing assembly to the mirrored face cabinet, the face panel of the light diffuser housing oriented outward at an acute angle to a plane located on a mirrored face of the mirrored face cabinet, a light source located inside the light diffuse housing and a power source for the light source in the light diffuser housing located in the rectangular box attachment section.

### DRAWINGS

FIG. 1 is an isometric view of the present invention.

FIG. 2 is a front view of the present invention.

FIG. 3 is a rear view of the present invention.

FIG. 4 is a left side view of the present invention.

FIG. 5 is a right side view of the present invention.

FIG. 6 is a top view of the present invention.

FIG. 7 is a bottom view of the present invention.

FIG. 8 is a view of the present invention shown installed in a wall.

FIG. 9 is a partial condensed cross-sectional view of the invention along line A-A on FIG. 4.

FIG. 10 is an exposed view of a rectangular box section and light diffuser housing assembly of the present invention.

FIG. 11 is a rear view of a rear view of a rectangular box section and light diffuser housing assembly of the present invention.

FIG. 12 is a front isometric view of a rectangular box section and light diffuser housing assembly of the present invention.

FIG. 13 is a rear isometric view of a rectangular box section and light diffuser housing assembly of the present invention.

FIG. 14 is a partial view of a rectangular box section and light diffuser housing assembly attached to a medicine cabinet.

FIG. 15 is a top view showing light projection patterns to a person standing in front of several size embodiments of the present invention.

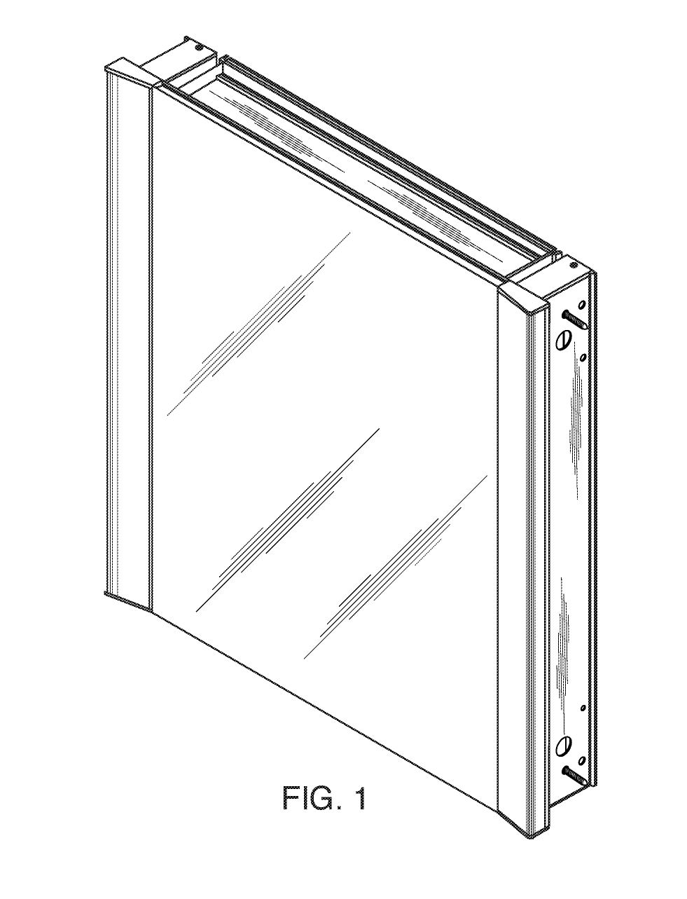

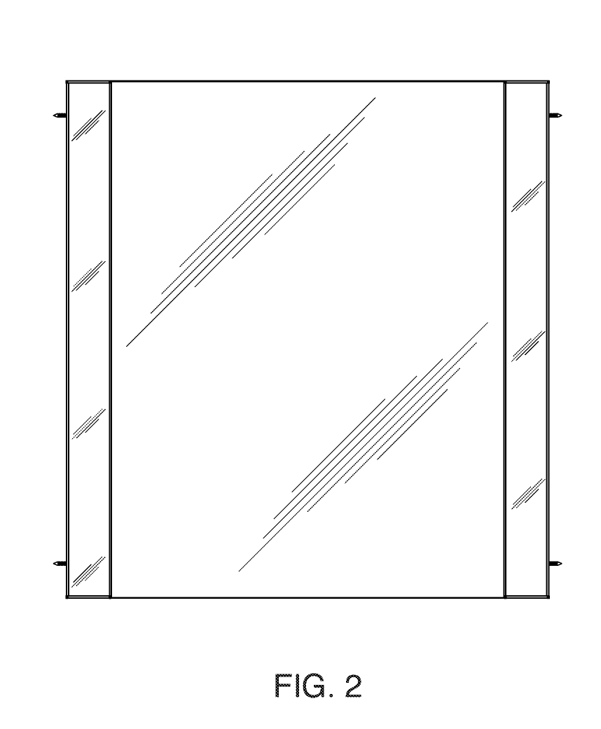

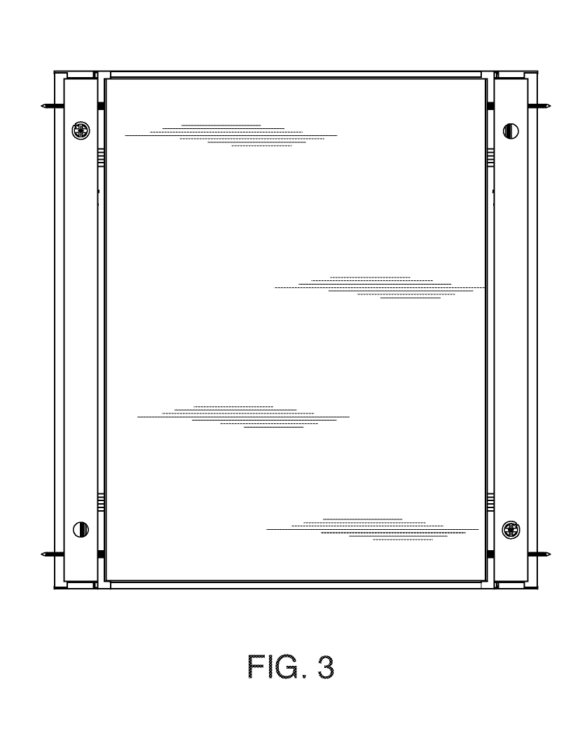

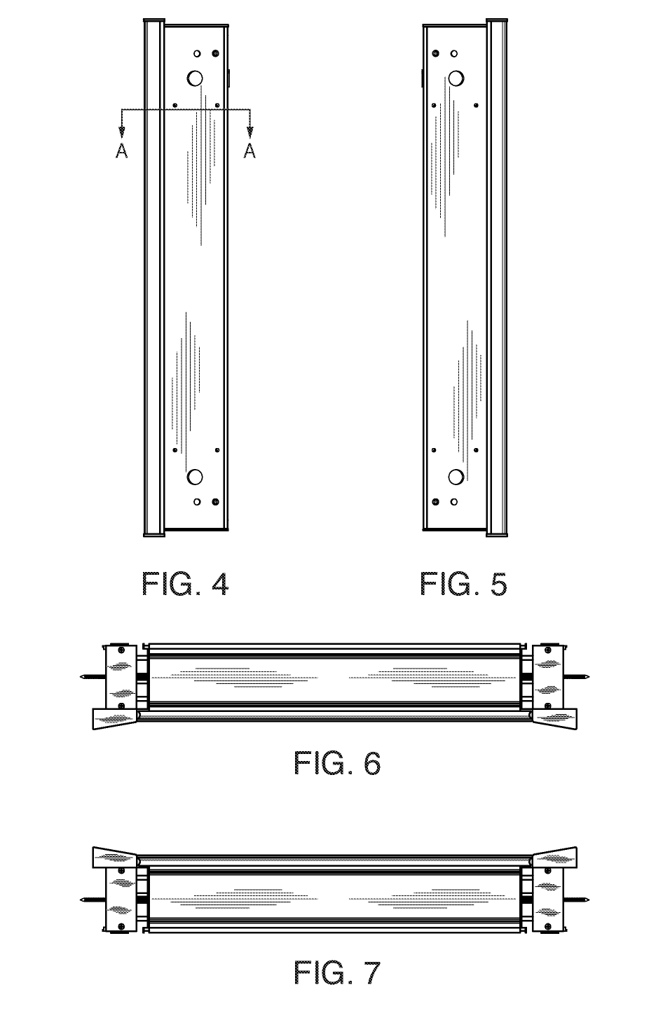

### DETAILED DESCRIPTION OF INVENTION

The present invention will now be described in terms of the presently preferred embodiment thereof as illustrated in the drawings. Those of ordinary skill in the art will recognize that many obvious modifications may be made thereto without departing from the spirit or scope of the present invention.

Personal grooming while standing in front of a mirrored medicine cabinet is an activity which requires task lighting. Often, mirrored medicine cabinets are installed in bathrooms where the ceiling light fixtures (often recessed lighting) are inadequate to supply the proper quantity of visible light (referred to and measured in lumens) and proper light color (referred to and measured on degrees Kelvin temperature) for this task. A preferred embodiment of the present invention provides for side mounted vertical light attachments to a standard medicine cabinet with a mirrored front door. Light-emitting diode (“LED”) strips are mounted inside the side mounted attachment light diffuser housing. The front panels of the vertical light attachments are—in a preferred embodiment—translucent white opal acrylic plastic. The front panels of the light diffusers are oriented at the optimum angle to direct light to a plane in space where the face of a person standing in front of the mirror would be located.

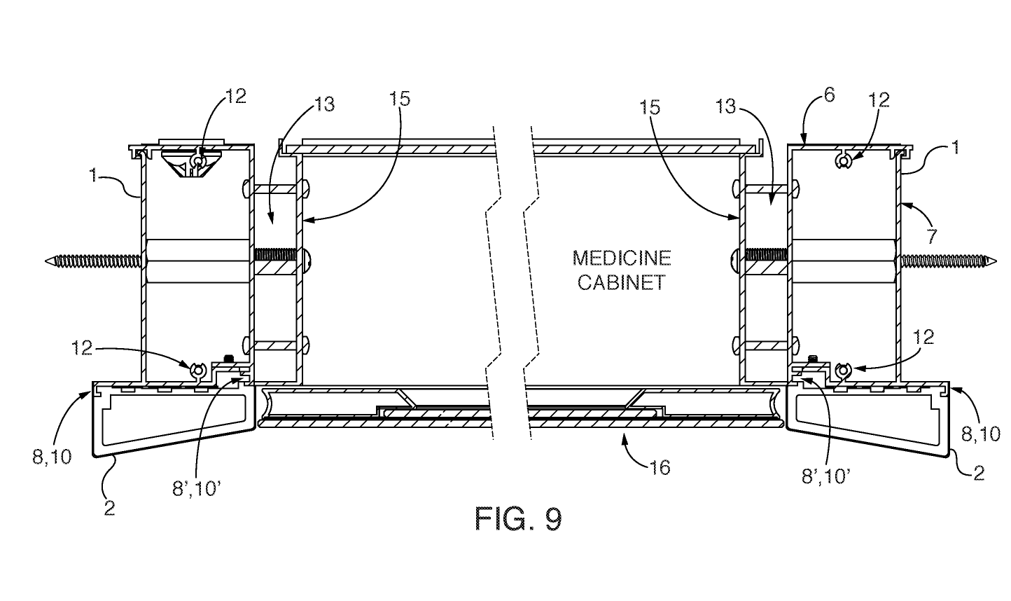

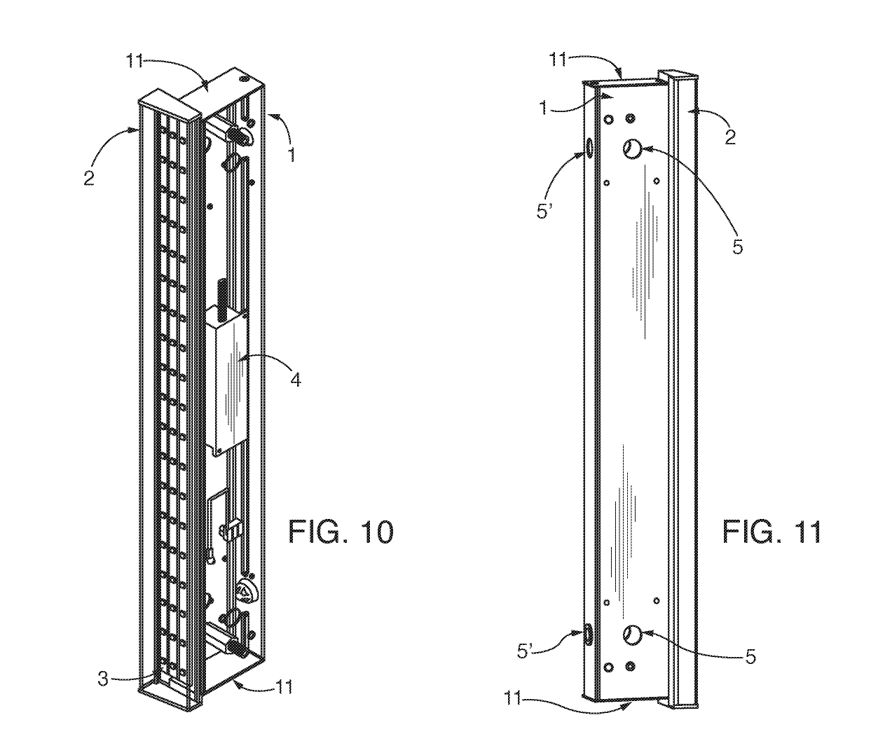

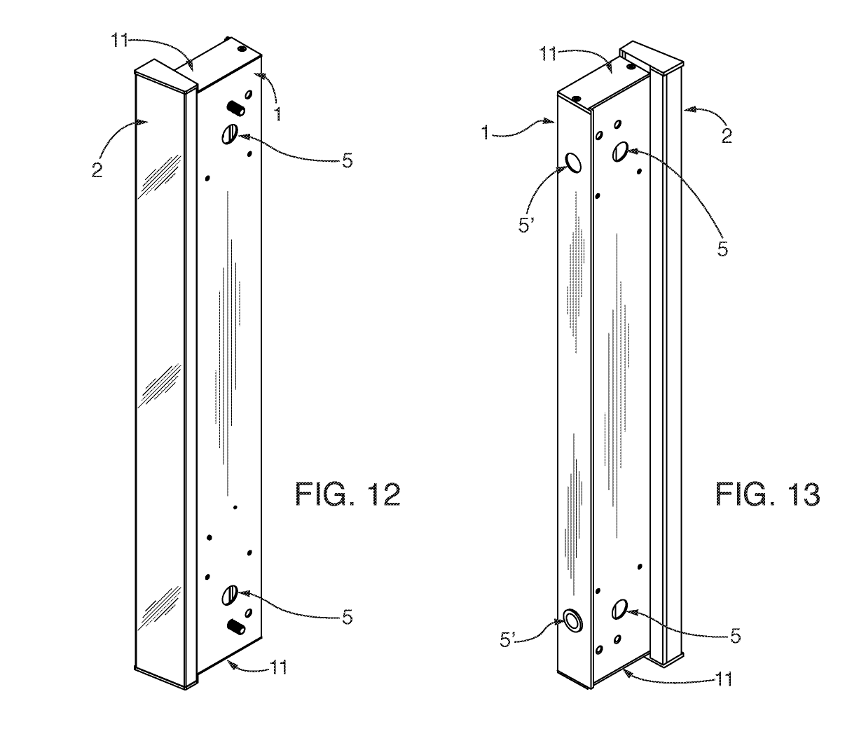

The vertical linear light assembly is made up of a rectangular box attachment section 1 and light diffuser housing 2 mounted to the front of the rectangular box attachment section. FIG. 12 and FIG. 13. LED light strips 3 are installed inside the light diffuser housing 2 and the light generated by them projects out of the diffuser housing 2. FIG. 10. A power source/transformer 4 is mounted in the rectangular box attachment section 1 that feeds the LED light strips 3. FIG. 10. The vertical linear light assemblies are mounted to the vertical sides 15 of a medicine cabinet. FIG. 9. Standard home electrical power (110 Volt A/C) is provided to the power source/transformer 4 through holes 5 or 5′ in the side wall or rear wall of the rectangular box attachment section 1. FIG. 11.

The rectangular box attachment section 1 is constructed by assembling two right angle plastic extrusions 6 and 7 that make up the four walls of the rectangular box attachment 1 by a snap and grove arrangement. FIG. 9. The front panel of the rectangular box attachment 1 has vertical opposing grove races 8 and 8′ which run the entire length of the rectangular box attachment. FIG. 9. The rectangular box attachment section 1 panels are all opaque.

The light diffuser housing 2 is one piece and channel shaped, translucent and in a preferred embodiment white opal acrylic plastic. FIG. 9. The side panels of the channel shaped portion of the light diffuser housing 2 have companion opposing vertical grove races 10 and 10′ which run the entire length of the light diffuser housing. FIG. 9. These companion opposing vertical grove races 10 and 10′ in the side panels of the channel shaped light diffuser housing 2 mate with the vertical opposing grove races 8 and 8′ which run the entire length of the front panel of the rectangular box attachment section 1. FIG. 9. So, once the rectangular box attachment section 1 is assembled, the light diffuser housing bottom edge is lined up with the top front edge of the rectangular box attachment section 1 and slid into place by inserting the grove edge of the light diffuser housing 2 into the channel edge of the rectangular box attachment section 1 and sliding it down into place. This process is repeated for the vertical linear light for the other side of the medicine cabinet.

The rectangular box attachment section/light diffuser housing assemblies (see FIG. 12 and FIG. 13) are completed by placing and securing the top and bottom caps 11 on the top and bottom, respectively, of these assemblies. FIG. 12 and FIG. 13. The top and bottom caps 11 are secured by screws going through the caps and into receiver holes 12 molded into the top and bottom sections of the rectangular box attachment section. FIG. 9.

The completed vertical light assemblies—one for the right side and one for the left side of the cabinet—(see FIG. 12 and FIG. 13) are attached to the vertical side walls of a medicine cabinet 15 and located by standoff spacer components 13 between the inner side panel of the rectangular box attachment 1 and the outer vertical wall of a medicine cabinet 15. FIG. 9. These standoff spacer components 13 facilitate the setting in place of the completed vertical light assemblies (FIG. 12 and FIG. 13) in relation to the medicine cabinet and particularly the mirrored front door 16 and also act as a transition piece integral to the mounting of the completed assemblies to the vertical side walls of the medicine cabinet 15. FIG. 9. Screws are inserted through the inner side panel of the rectangular box attachment through receiver holes molded into the standoff spacer components and into the outer vertical walls of a medicine cabinet to secure the completed vertical light assemblies to the sides of the medicine cabinet. FIG. 9.

Before assembly, LED light strips 3 are arranged vertically inside the front panel of the rectangular box attachment section 1. FIG. 10. The LED light strips are oriented to project out of the translucent light diffuser housing 2 which mounts to the front panel of the rectangular box attachment section 1 over the LED 3 light strips. FIG. 10. When illuminated, the LED light strips provide light through the translucent light diffuser housing 2.

Also before assembly, a power source/transformer 4 for the LED light strips 3 is mounted in the rectangular box attachment section 1. FIG. 10. This power source/transformer 4 is powered by an electrical connection to a standard home electrical service 110 volt AC by connection into the side panels of the vertical linear light assembly by means of holes 5 in the inner side wall or by means of hole 5′ in the back wall of the rectangular box attachment section. FIG. 11. The preferred embodiment for this arrangement is that a separate wall switch would be used to activate the LED light strips 3 in the light diffuser housing 2 energized by this power source/transformer 4 mounted in the rectangular box attachment section 1.

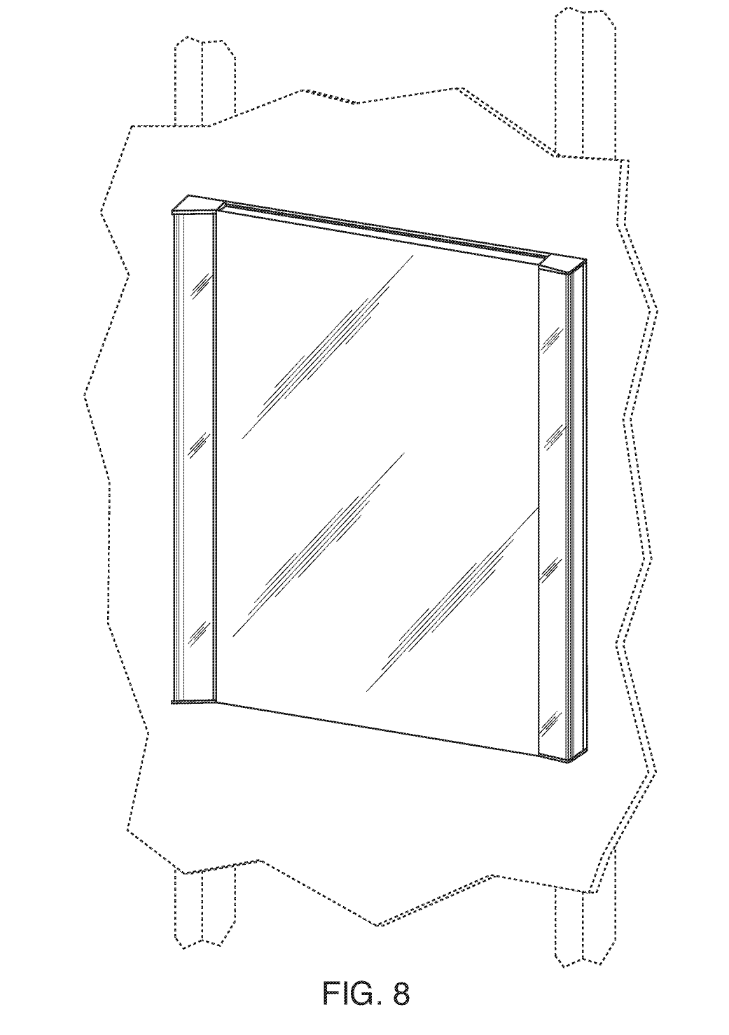

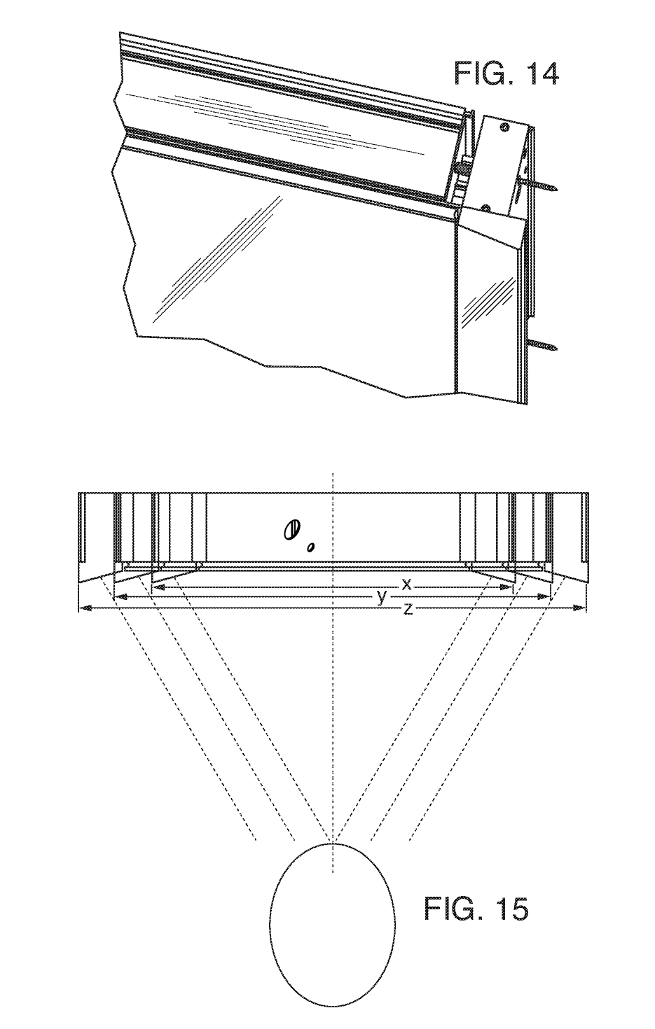

Once the completed vertical light assemblies are mounted to the sides of a medicine cabinet (FIG. 14), the medicine cabinet is either mounted into the wall between studs (FIG. 8) or flush mounted onto the wall in the desired location. The power from the home electric service used to power the LED strip lights 3 is fed either through a hole in the back panel 5′ or a hole in the side panel 5 of the vertical linear light assemblies. FIG. 11.

The user of a medicine cabinet equipped with side mounted vertical light assemblies will experience a sufficient quantity of visible light—typically in the range of 1600 lumens—and proper light color—typically in the range of 2700 Kelvin—for their personal grooming tasks. This combination of light quantity (1600 lumens) light color (2700 Kelvin) provides optimal task lighting for grooming activities. FIG. 15. Of course, the quantity of light, color of light and standard dimensions of the light spacing are not critical to the present invention and merely provide preferred embodiments; the present invention is intended to and can operate in any chosen range of these and other variables without deviating from the spirit and purpose of the present invention.

1. A pair of vertical linear light attachments for a mirrored face cabinet each comprising:
a rectangular box attachment section with an inner side panel, an outer side panel, a back panel and a front panel all made from opaque material;
a light diffuser housing with a face panel and two side panels adapted to be attached to the front panel of the rectangular box attachment section;
a top cap section and a bottom cap section adapted to be attached to the rectangular box attachment section where the top cap section and bottom cap section cover the top and bottom of both the rectangular box attachment section and the light diffuser housing;
the light diffuser housing made from translucent material;
the top cap section and bottom cap section made from opaque material;
the inner side panel of the rectangular box attachment section adapted to be mounted to an outer vertical side wall of the mirrored face cabinet to affix the rectangular box attachment section and light diffuser housing assembly to the mirrored face cabinet;
the face panel of the light diffuser housing oriented outward at an acute angle to a plane located on a mirrored face of the mirrored face cabinet;
a light source located inside the light diffuser housing;
a power source for the light source in the light diffuser housing located in the rectangular box attachment section.

2. The pair of vertical linear light attachments of claim 1, wherein the acute angle to a plane located on a mirrored face of the mirrored face cabinet at which the face panel of the light diffuser housing is oriented outward is 15 degrees.

3. The pair of vertical linear light attachments of claim 1, wherein the rectangular box attachment section and the top cap section and bottom cap sections of the light diffuser housing are fabricated from sheet metal.

4. The pair of vertical linear light attachments of claim 2, wherein the rectangular box attachment section and the top cap section and bottom cap sections of the light diffuser housing are fabricated from sheet metal.

5. The pair of vertical linear light attachments of claim 1, wherein the light source inside the light diffuser housing is an LED.

6. The pair of vertical linear light attachments of claim 2, wherein the light source inside the light diffuser housing is an LED.

7. The pair of vertical linear light attachments for a mirrored face medicine cabinet of claim 1, wherein the mirrored face cabinet is a medicine cabinet with a mirrored door.

8. The pair of vertical linear light attachments for a mirrored face medicine cabinet of claim 2, wherein the mirrored face cabinet is a medicine cabinet with a mirrored door.

9. A mirrored face cabinet, comprising:
an outer housing having opposed vertical and horizontal side walls, an openable front door with at least one mirror on its face, an internal storage cavity and opposed side vertical walls on the inside and outside of the cabinet;
two rectangular box attachment sections and light diffuser housing assemblies mounted to the opposed outside vertical side walls of the mirrored face cabinet;
each rectangular box attachment section and light diffuser housing assembly comprised of an inner side panel, an outer side panel, a back panel and a front panel all made from opaque material; the light diffuser housing with a face panel and two side panels adapted to be attached to the front panel of the rectangular box attachment section, a top cap section and a bottom cap section adapted to attach to the rectangular box attachment section where the top cap section and bottom cap section cover the top and bottom of both the rectangular box attachment section and the light diffuser housing, the light diffuser panel made from translucent material, the top cap section and bottom cap section made from opaque material, the inner side panel of the rectangular box attachment section adapted to be mounted to the outer side vertical walls of the mirrored face cabinet to affix the rectangular box attachment section and light diffuser housing assembly to the mirrored face cabinet; the face panel of the light diffuser housing oriented outward at an acute angle to a plane located on the mirrored face of the mirrored face cabinet; a light source located inside the light diffuser housing and a power source for the light source in the light diffuser housing located in the rectangular box attachment section.

10. The mirrored face cabinet of claim 9, wherein the acute angle to a plane located on a mirrored face of the mirrored face cabinet at which each face panel of the light diffuser housing is oriented outward is 15 degrees.

11. The mirrored face cabinet of claim 9, wherein each rectangular box attachment section and the top cap section and bottom cap sections of both light diffuser housing is fabricated from sheet metal.

12. The mirrored face cabinet of claim 10, wherein each rectangular box attachment section and the top cap section and bottom cap sections of both light diffuser housing is fabricated from sheet metal.

13. The mirrored face cabinet of claim 9, wherein the light source inside both light diffuser housings is an LED.

14. The mirrored face cabinet of claim 10, wherein the light source inside both light diffuser housings is an LED.

15. The mirrored face cabinet of claim 9, wherein the mirrored face cabinet is a medicine cabinet with a mirrored door.

16. The mirrored face cabinet of claim 10, wherein the mirrored face cabinet is a medicine cabinet with a mirrored door.

17. The mirrored face cabinet of claim 11, wherein the mirrored face cabinet is a medicine cabinet with a mirrored door.

18. The mirrored face cabinet of claim 12, wherein the mirrored face cabinet is a medicine cabinet with a mirrored door.

19. The mirrored face cabinet of claim 13, wherein the mirrored face cabinet is a medicine cabinet with a mirrored door.

20. The mirrored face cabinet of claim 14, wherein the mirrored face cabinet is a medicine cabinet with a mirrored door.
